(19) United States
(12) Patent Application Publication
(10) Pub. No.: US 2008/0205879 A1
(43) Pub. Date: Aug. 28, 2008

(54) Opening and Closing Apparatus For Small Image Photographing Devices

(75) Inventor: Jae-Young Park, Gyeonggi-do (KR)

Correspondence Address: HARNESS, DICKEY, & PIERCE, P.L.C, 7700 Bonhomme, Suite 400, ST. LOUIS, MO, 63105, US

(73) Assignee: M2SYS CO., LTD., Bucheon-si, Gyeonggi-do (KR)

(21) Appl. No.: 11/994,902

(22) PCT Filed: Apr. 21, 2006
(86) PCT No.: PCT/KR06/01510

§ 371 Date: Jan. 7, 2008

(30) Foreign Application Priority Data
Jul. 15, 2005 (KR) 10-2005-0064330
Jul. 15, 2005 (KR) 10-2005-0064334
Feb. 17, 2006 (KR) 10-2006-0015763

(51) Int. Cl. G03B 9/20; G03B 9/08

(52) U.S. Cl. 396/463; 396/497

(57) ABSTRACT

Disclosed is a shutter apparatus for small cameras. According to the first embodiment of the invention, a shutter housing is mounted in an exposure aperture formed in a main body. The shutter housing has a through-hole communicated with the exposure aperture. A shutter panel is pivotably mounted inside the shutter housing so as to open and close the through-hole. A pivot lever is rotatably installed inside the shutter housing and engaged with the shutter panel such that the shutter panel is pivoted to open and close the through-hole. Thus, the opening is opened only when the camera is used to take a picture, and otherwise the opening is closed, thereby efficiently preventing introduction of foreign matters into the inside of the camera.

### TECHNICAL FIELD

The present invention relates to a shutter apparatus for small cameras capable of being installed in the camera opening, in which the opening is opened only when the camera is used to take a picture, and otherwise the opening is closed, thereby preventing damage of the camera due to external impact and efficiently preventing introduction of foreign matters into the inside of the camera.

### BACKGROUND ART

Recently a small communications device such as cellular phones has been equipped with a small camera for taking a picture of a subject.

Among these small cameras, a short-focal camera includes multiple lenses for transmitting a subject image and an image sensor for processing the transmitted image, which are all integrated with the camera.

In case of such camera, all components are fixed inside of the case and shielded from outside. Only the outmost lens is exposed to the outside.

Thus, dirt or the like tends to stick to the outmost lens so that the taken image can be blurred.

On the other hands, recently auto-focusing and zooming functions have been added to the small camera according to the users demand.

In order to perform such auto-focusing and zooming, the lenses must be driven in a mechanical way to adjust the distances between the respective lenses and between the lens and the image sensor.

Accordingly, a sophisticated drive mechanism must be installed inside of the small functional camera, which therefore can not be closed from outside, dissimilar to short-focal small camera.

Thus, foreign matters are introduced into the inside of the camera through the camera opening, through which light is transmitted. The introduced foreign matters degrade the performance of the camera driving components.

In particular, if fine dusts stick to the image sensor, the image quality is extremely degraded, incomparably to the case where foreign matters stick to the lens. Furthermore, the dust stuck to the image sensor cannot be cleaned up to lead to failure of the whole camera.

Therefore, there needs a device for shielding the camera opening from foreign matters.

Hereinafter, a conventional technique will be explained illustrating a small camera embedded in a portable terminal.

FIG. 24 is a sectional view showing a conventional portable terminal equipped with a small camera.

As shown in FIG. 24, a portable terminal includes a printed circuit board (not shown) mounted thereinside, a main body 1 and a folder 2 connected to the upper end of the main body 1 by means of a hinge connection 5. A battery 6 is detachably attached to one side of the main body 1.

A small camera 3 is embedded at one side of the folder 2. This camera 3 is coupled to the printed circuit board inside of the main body 1 and exposed to outside through an exposure aperture 2a formed in the folder 2. In the figure, unexplained reference number 4 denotes an antenna.

The above small camera 3, mounted in a portable terminal, remains exposed through the exposure aperture 2a of the folder 2. Thus, external impact may damage the camera and the camera 3 and the exposure aperture 2a may be contaminated by foreign matters such as dirt or dust to thereby adversely affect the quality of image.

### DISCLOSURE OF INVENTION

Technical Problem

The present invention has been made in view of the above problems, and it is an object of the invention to provide a shutter apparatus for small cameras capable of being installed in the opening of a small camera, in which the opening is opened only when the camera is used to take a picture, and otherwise the opening is closed, thereby preventing damage of the camera due to external impact and efficiently preventing introduction of foreign matters into the inside of the camera.

Technical Solution

In order to achieve the above object, according to an aspect of the invention, there is provided a shutter apparatus for small cameras, comprising: a shutter housing to be mounted in an exposure aperture formed in a main body and having a through-hole communicated with the exposure aperture; a shutter panel pivotably mounted inside the shutter housing so as to open and close the through-hole; and a pivot lever rotatably installed inside the shutter housing and engaged with the shutter panel such that the shutter panel is pivoted to open and close the through-hole.

In an embodiment, the shutter panel includes: a cover portion having a semi-circular shape; a pivot portion having an expanded region, the pivot portion having at one end portion thereof a pivot hole forming a pivot center; and a guide portion extended from the pivot portion in opposite direction to the cover portion and having a guide hole in the form of an elongated slot.

In an embodiment, the pivot lever has an annular disk shape having an inner diameter corresponding to the through-hole, a guide pin formed at 180 degrees intervals so as to be inserted into the guide hole, and a handle formed in the periphery thereof so as to be protruded outside of the shutter housing.

In an embodiment, the apparatus further comprises a tension spring, in which one end of the tension spring is fixed to the pivot lever and the other end thereof is fixed to the shutter housing such that a force is exerted in the direction of closing the shutter panel, thereby the shutter panel remaining at closed state.

In an embodiment, the shutter housing has a pivot protrusion formed at 180 degree intervals so as to be inserted into the pivot hole.

In an embodiment, the pivot lever is provided with at least one resilient stopper and the shutter housing is provided with a stopper retainer hole for temporarily holding the stopper, such that the shutter panel and the pivot lever are temporarily held in place at open and closed state of the through-hole.

In an embodiment, the apparatus further comprises an adhesive sheet for attaching the shutter housing to the main body.

In an embodiment, the apparatus further comprises a cover mounted on outer side face of the main body and for wrapping around and fixing the shutter housing.

According to an aspect of the invention, there is provided shutter apparatus for small cameras, the apparatus comprising: a hollow frame fixed at the edge of opening of a main body; a shield plate installed in central area of the frame, the shield plate having a first opening for opening the camera opening; a wound coil fixed on the frame, the wound coil establishing electromagnetic field by a power supply; a controller for selectively supplying a forward and reverse current; a drive plate rotatably installed in the frame so as to be parallel to the shield plate, the drive plate having a second opening formed so as to be aligned with the first opening; first magnet and second magnet fixed on the drive plate with a certain distance in-between so as to be alternatively placed within the electromagnetic field, the polarities of the magnets towards the wound coil being in opposite to each other; a blade shaft-supported on the shield plate so as to be contacted with the drive plate such that the blade is pivoted by rotation of the drive plate to thereby open and close the first opening.

In an embodiment, a magnetic member is fixed to center of the coil, the magnetic member concentrating magnetic field to one of the first magnet and the second magnet.

In an embodiment, the blade is provided with an elongated hole, and the drive plate is provided with a protrusion so as to be engaged with the elongated hole.

In an embodiment, the apparatus further comprises a cover plate combined to the frame for the coil to be rested thereon and for preventing the drive plate from being escaped, the cover plate having a third opening formed to be aligned with the first opening.

According to an aspect of the invention, there is provided a shutter apparatus for small cameras, the shutter apparatus comprising: a ring-shaped frame fixed to the edge of an opening of a main body; a shield plate installed in the central region of the frame and having a first opening formed so as to open the opening; a handle slidably installed on the frame; a rack gear fixed to the handle so as to enable to slide and having a first gear tooth formed therein; a first link shaft-supported on the shield plate, the first link having a second gear tooth engaged with the first gear tooth and formed on a circumference having a desired radius from the shaft-supported rotation center; and a first blade slidably installed in the shield plate so as to receive the rotation of the first link in the form of a linear motion to open and close the first opening.

In an embodiment, a first elongated slot is formed in the first link and the first blade is provided with a first protrusion formed so as to be coupled to the first elongated slot.

In an embodiment, the apparatus further comprises a cover plate coupled to the frame such that the handle and the first blade are prevented from escaping.

In an embodiment, the apparatus further comprises: a second link shaft-supported on the shield plate, the second link including a third gear tooth to be engaged with the second gear tooth and formed on a circumference having a desired radius from the shaft-supported rotation center; and a second blade slidably installed in the shield plate so as to receive the rotation of the second link in the form of a linear motion to open and close the first opening.

In an embodiment, a second elongated slot is formed in the second link and the second blade is provided with a second protrusion formed so as to be coupled to the second elongated slot.

In an embodiment, the apparatus further comprises a cover plate coupled to the frame such that the handle and the first and second blades are prevented from escaping, the cover plate being provided with a second opening formed so as to be aligned with the first opening.

According to an aspect of the invention, there is provided a shutter apparatus for small cameras, the apparatus comprising: a shield frame being installed frontward of the lens of a camera and having a sliding space for opening the front side of the lens; a blade sliding in the sliding space 412 to open and close the front side of the lens, the blade having a protrusion; and a rotation lever rotatably coupled to the shield frame, the rotation lever including a central opening formed in rotation center thereof to open the front side of the lens and a cam groove coupled to the protrusion such that the protrusion moves to open and close the blade, when the rotation lever rotates.

In an embodiment, the blade includes a pair of blades symmetrically disposed and the protrusion and the cam groove includes a pair of protrusions and a pair of cam grooves respectively.

In an embodiment, a stopping groove is formed in one of the shield frame and the rotation lever, and the other one thereof is provided with a guide rib formed to be coupled to the stopping groove to limit rotation angle of the rotation lever.

In an embodiment, the rotation lever is provided with a handle protruded so as to be pushed by a user.

In an embodiment, the apparatus further comprises a cover member to be coupled to the shield frame to thereby prevent escape of the blade.

Advantageous Effects

As described above, with the shutter apparatus of the invention, the camera opening is opened only when the camera is used to take a picture, and otherwise the opening is closed, thereby enable to prevent damage of the camera due to external impact and efficiently avoid introduction of foreign matters into the inside of the camera.

### BRIEF DESCRIPTION OF THE DRAWINGS

FIG. 1 is a partial sectional view showing a shutter apparatus for small cameras according to a first embodiment of the invention.

FIG. 2 is a partial perspective view of the shutter apparatus of FIG. 1.

FIG. 3 is an exploded view of the shutter apparatus of FIG. 1.

FIG. 4 is a sectional view of the shutter apparatus of FIG. 1 where the through-hole of the apparatus is closed.

FIG. 5 is a sectional view of the shutter apparatus of FIG. 1 where the through-hole of the apparatus is opened.

FIG. 6 is a perspective view of a shutter apparatus for small cameras according to a second embodiment of the invention.

FIG. 7 is a sectional view of a shutter apparatus for small cameras according to a third embodiment of the invention.

FIG. 8 is a perspective view of a shutter apparatus for small cameras according to a fourth embodiment of the invention.

FIG. 9 is a perspective rear view of the shutter apparatus of FIG. 8.

FIG. 10 is a perspective view showing major components of the shutter apparatus shown in FIG. 8.

FIG. 11 is a perspective view of the shutter apparatus of FIG. 8 where the cover plate thereof is excluded.

FIGS. 12 and 13 show the shutter apparatus of FIG. 11 when in use.

FIG. 14 is an exploded perspective view of a shutter apparatus for small cameras according to a fifth embodiment of the invention.

FIGS. 15 and 16 is a perspective view showing major components of the shutter apparatus of FIG. 14.

FIGS. 17 and 18 are sectional view showing operation of the shutter apparatus of FIG. 14.

FIG. 19 is an exploded perspective view of a shutter apparatus for small cameras according to a sixth embodiment of the invention.

FIG. 20 is an exploded perspective view of the shutter apparatus of FIG. 19 seen from a different angle.

FIGS. 21 to 23 are perspective views showing the internal structure of the shutter apparatus of FIG. 19.

FIG. 24 is a sectional view showing a conventional portable terminal equipped with a small camera.

### MODE FOR THE INVENTION

Hereafter, preferred embodiments of the invention will be explained in greater detail, with reference to the accompanying drawings.

A first embodiment of the invention will be described illustrating a shutter apparatus for a small camera, which can be installed in a portable terminal.

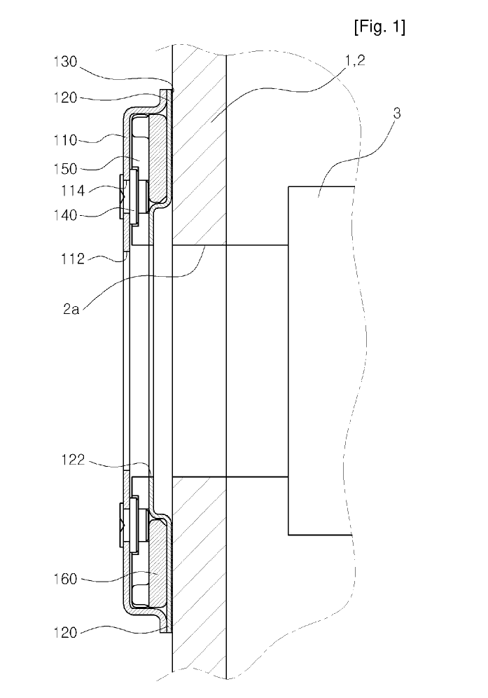

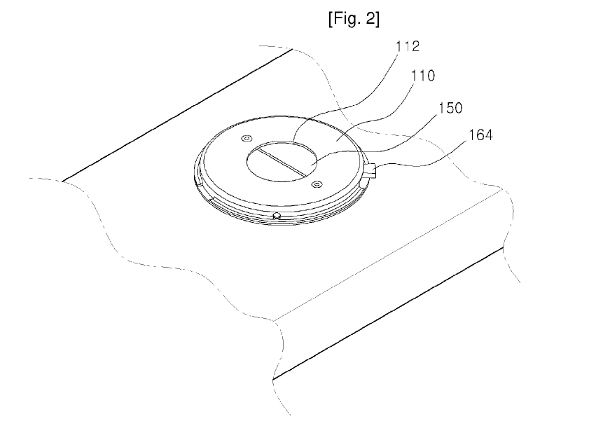

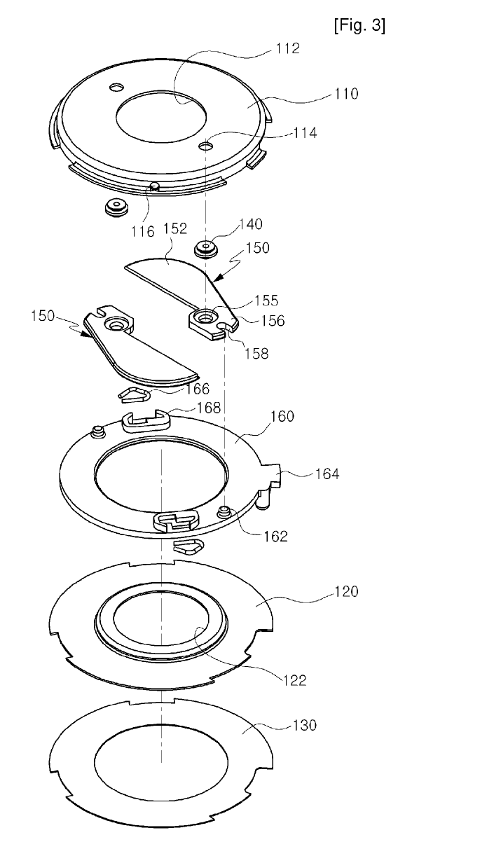

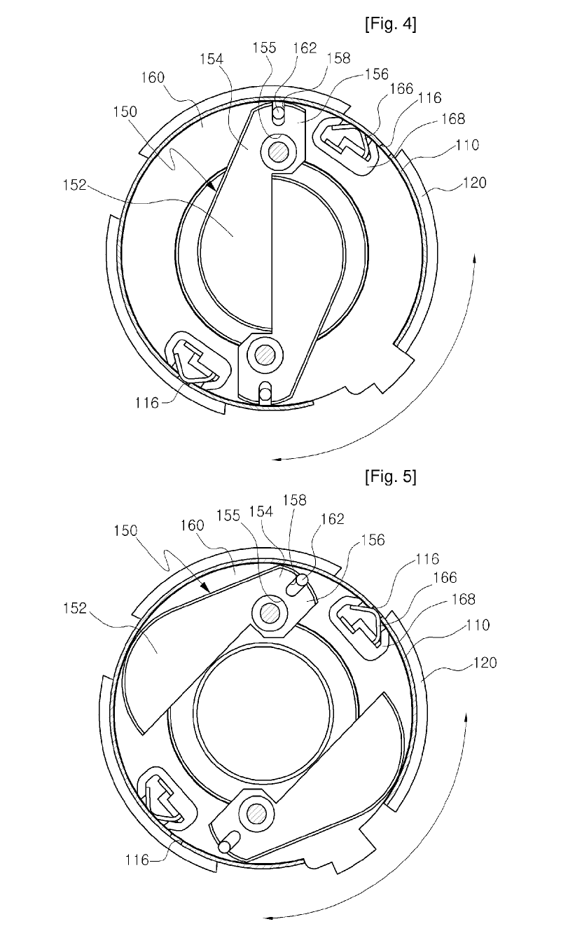

FIG. 1 is a partial sectional view of a shutter apparatus for small cameras according to the first embodiment of the invention. In FIG. 1, the shutter apparatus is installed in a portable terminal equipped with a small camera. FIG. 2 is a partial perspective view of the shutter apparatus of FIG. 1. FIG. 3 is an exploded view of the shutter apparatus of FIG. 1. FIG. 4 is a sectional view of the shutter apparatus of FIG. 1 where the through-hole of the apparatus is closed. FIG. 5 is a sectional view of the shutter apparatus of FIG. 1 where the through-hole of the apparatus is opened.

Referring to FIGS. 1 to 5, the shutter apparatus of small cameras (hereinafter, referred to as a shutter apparatus) according to the first embodiment of the invention can be applied to both a main body 1 and the folder 2 of a portable terminal.

A small camera 3 is housed in the main body 1 or the folder 2, and connected to a printed circuit board mounted inside of the main body 1. When required, the camera 3 is exposed to the outside through an exposure aperture 2a and takes a photograph of a subject.

The shutter apparatus of the first embodiment is mounted at the edge of the exposure aperture 2a. The shutter apparatus includes a shutter housing 100 having an upper shutter housing 110 and a lower shutter housing 120, which are combined to form an internal accommodation space. The upper shutter housing 110 and lower shutter housing are provided respectively with through-holes 112 and 122 communicated with the exposure aperture 2a. A shutter panel 150 is rotatably installed inside the shutter housing 100 so as to enable to open and close the through holes 112 and 122 in a symmetrical fashion. A pivot lever 160 is rotatably installed inside the shutter housing 100 such that it is connected to the shutter panel 150 so as to rotate the shutter panel 150 to open and close the through-holes 112 and 122.

The lower shutter housing 120 is provided at its bottom face with an adhesive sheet 130 to allow the shutter housing 100 to be attached to the edge of the exposure aperture 2a.

The shutter panel 150 includes a cover portion 152, a pivot portion 154, and a guide portion 156. The cover portion 152 has a semicircular shape so as to cover half of the through-holes 112 and 122. The pivot portion 154 has an expanded area at one end portion of the cover portion and a pivot hole 155. The guide portion 156 is extended from the pivot portion 154 in the opposite direction to the cover portion 152 and has a slot-type guide hole 158 formed at the central one of the end portion thereof.

A pivot protrusion 140 is inserted into the pivot portion 154 of the shutter panel 150, which is then shaft-supported on the upper shutter housing 110. The upper shutter housing 110 is provided at radially symmetrical positions respectively with a fixing hole 114 for holding the pivot protrusion 140.

The pivot lever 160 has the shape of an annular disk having an inner diameter, which corresponds to the through-holes 112 and 122. One face of the pivot lever 160 is provided with a guide pin 162 respectively at radially symmetrical positions to be inserted into the guide hole 158. The pivot lever 160 is provided with a stopper mount 168 at radially symmetrical positions, where a resilient stopper 166 is mounted so as to protrude by a certain length beyond the outer circumference of the pivot lever 160. In addition, the pivot lever 160 is provided with a handle 164 formed so as to protrude by a certain length outside of the shutter housing 100, so that a user can grip the handle to rotate the pivot lever.

The upper shutter housing 110 is provided with a stopper retainer hole 116 for receiving the stopper 166 such that the pivot lever 160 can be temporarily held in place at opening and closing states of the through-holes 112 and 122.

At this time, a single stopper 166 may be installed and the stopper retainer hole 116 may be formed at positions of the stopper 166, which correspond to the opening and closing states of the through-holes 112 and 122 respectively. On the other hand, as shown in the figures, it is preferable that the stopper retainer holes 116 are formed at positions of the stoppers 166 in radially symmetrical positions.

The above-constructed shutter apparatus according to the first embodiment of the invention is applicable to a camera embedded in a portable terminal, i.e., mounted at the edge of the exposure aperture 2a of the portable terminal or the camera. Thus, the shutter apparatus protects the camera exposed to outside through the exposure aperture 2a to thereby avoid introduction of foreign matters into the camera or damage of the camera.

The installation and operation of the shutter apparatus will be explained in greater detail.

When the camera equipped in a portable terminal is not used, as shown in FIG. 4, the handle 164 of the pivot lever 160 is moved to the closed position. Then, rotation of the pivot lever 160 moves the position of the guide pin 162 by certain degrees.

If the guide pin 162 rotates while sliding in the guide hole 158, a force is exerted perpendicular to the length of the guide hole 158 such that the shutter panel 150 is rotated about the pivot hole 155.

In this way, the respective semi-circular cover portions 152 contact each other to cover the through-holes 112 and 122 to shield the camera 3 from outside.

At this time, if the pivot lever 160 rotates until the through-holes 112 and 122 is completely closed, the stopper 166 mounted at one side of the pivot lever 160 is inserted into the stopper retainer hole 116 so as to be temporarily held in place.

On the other hand, in order to take a photograph of a subject, as shown in FIG. 5, the handle 164 of the pivot lever 160 is moved to the opening position. That is, if the handle 164 is moved in opposite direction to FIG. 4, the pivot lever 160 rotates such that the position of the guide pin 162 moves by certain degrees in opposite direction to FIG. 4.

If the guide pin 162 rotates as described above, a force is exerted perpendicular to the length of the guide hole 158. Thus, the shutter panels 150 rotate about the pivot hole 155 in opposite direction to FIG. 4. Then, the shutter panels 150 forming a circle are separated from each other to open the through-holes 112 and 122 of the shutter housing 100.

At this time, the pivot lever 160 rotates until the through-holes 112 and 122 are completely opened. Thus, one stopper 166, temporarily inserted into one stopper retainer hole at the closed state, is elastically strained and released from the stopper retainer hole 116. Then, the other stopper 166 is inserted to the other stopper retainer hole 116 and then temporarily held in place.

The above-configured shutter apparatus of the first embodiment is mounded on top of the exposure aperture 2a of a portable terminal by means of an adhesive sheet 130. The small camera 3 embedded in the portable terminal is configured to be exposed through the exposure aperture 2a. Rotation of the pivot lever 160 allows the shutter panels 150 to be pivoted inside the shutter housing 100 such that the through-holes 112 and 122 can be opened and closed.

Thus, when the camera 3 is not used, the above shutter apparatus closes the through-holes 112 and 122 to enable to prevent introduction of foreign matters into the camera 3 and damage of the camera by an external force.

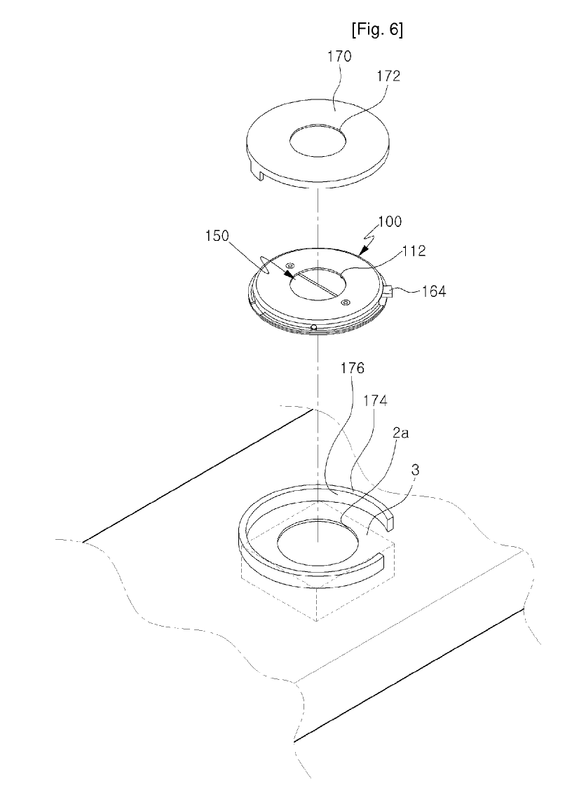

FIG. 6 shows a shutter apparatus for small cameras according to a second embodiment of the invention.

As shown in FIG. 6, a resting section 174 having a certain height is provided on one side of a portable terminal, in which a camera 3 is embedded and an exposure aperture 2a is formed. Formed in the resting section 174 is a resting recess 176 providing a certain depressed space.

Rested on the resting recess 176 is a shutter housing 100 having a shutter panel 150 and a pivot lever 160 mounted thereinside. A cover 170 is inserted into the resting section 174 such that the shutter housing 100 can be held in-between.

Formed in the central area of the cover 170 is a through-hole 172 having a shape corresponding to the through-hole 112.

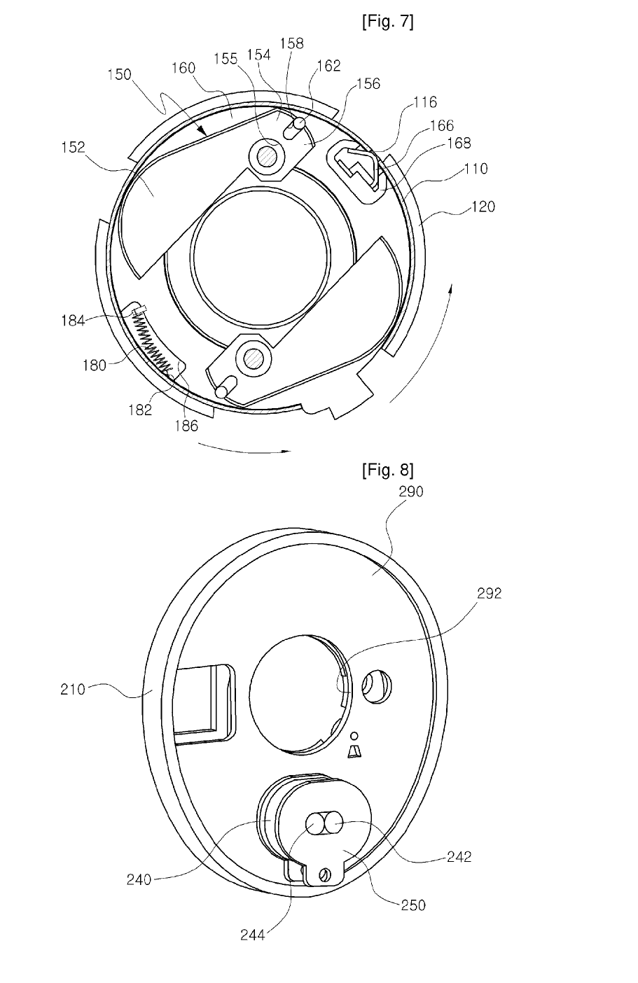

FIG. 7 shows a shutter apparatus of small cameras according to a third embodiment of the invention.

As shown in FIG. 7, a mounting recess 186 is formed at one side of the pivot lever 160 and a tension spring 180 is mounted in the mounting recess 186. At this time, one end of the tension spring 180 is fixed to a latching hook 182 formed in the shutter housing 100 and the other end thereof is fixed to a latching hook 184 formed in the pivot lever 160.

The tension spring 180 installed as above is biased to turn the cover portion 152 towards the closing position. That is, the tension spring 180 functions to retain the shutter panel 150 at closed state.

Here, the latching hook 182 may be formed in the upper shutter housing 110 or the lower shutter housing 120.

In addition, except that the tension spring 180 is mounted between the pivot lever 160 and the shutter housing 100, other elements are configured in the same manner as in the first embodiment.

In operation, when the handle 164 of the pivot lever 160 is pushed in order to close the cover portion 152, the stopper 166 is released from the stopper retainer hole 116 and simultaneously the tension spring 180 pulls the pivot lever 160, which is then rotated. Then, the rotation of the pivot lever 160 leads to rotation of the cover portion 152, which in turn closes the through-holes 112 and 122.

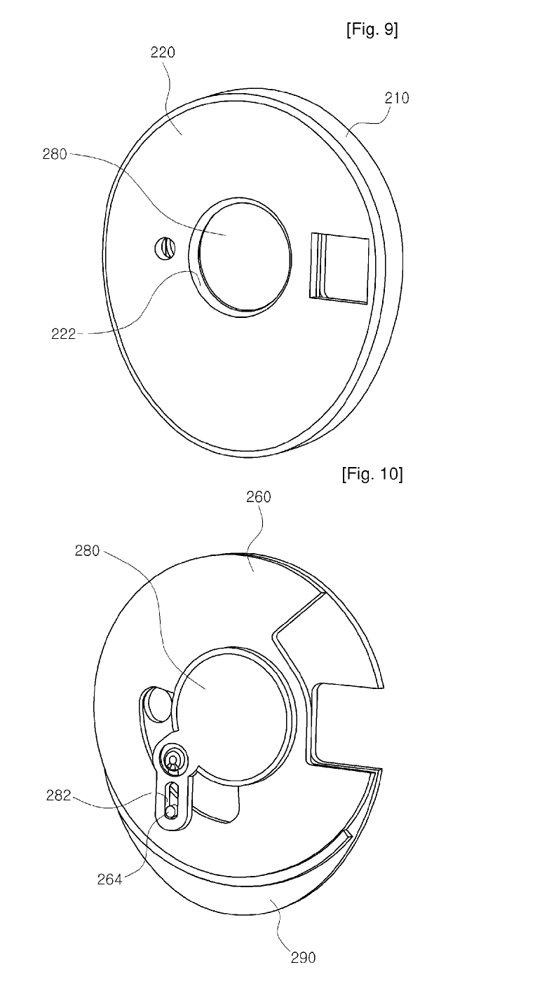

FIG. 8 is a perspective view of a shutter apparatus for small cameras according to a fourth embodiment of the invention. FIG. 9 is a perspective rear view of the shutter apparatus of FIG. 8. FIG. 10 is a perspective view showing major components of the shutter apparatus shown in FIG. 8.

In the shutter apparatus of the fourth embodiment, a hollow frame 210 is fixed at the edge of the opening of a small camera. Installed in the central area of the frame 210 is a shield plate 220 having a first opening 222 for opening the camera opening. A wound coil 240 is fixed on the frame 210. The wound coil 240 establishes electromagnetic field by a power supply. A controller is provided for selectively supplying a forward and reverse current. A drive plate 260 is rotatably installed in the frame 210 in parallel to the shield plate 220. The drive plate 260 is provided with a second opening 262 formed so as to be aligned with the first opening 222. A first magnet 270 and a second magnet 272 are fixed on the drive plate 260 with a certain distance in-between so as to be alternatively placed within the electromagnetic field. The polarities of the magnets towards the wound coil 240 are in opposite to each other. A blade 280 for opening and closing the first opening 222 is shaft-supported on the shield plate 220 so as to be contacted with the drive plate 260 such that the blade 280 is pivoted by rotation of the drive plate 260 to thereby open and close the first opening 222.

The frame 210 is installed at the edge of the camera opening, which is to be opened for transmitting light through the lens of the small camera. The small camera is sealed except for the opening.

The coil 240 is wound around a bobbin 250, and the bobbin 250 is fixed to the frame 210.

Fixed to the center of the bobbin 250 are a first magnetic member 242 and a second magnetic member 244 for concentrating magnetic field to one of the first and second magnets 270 and 272. When the first magnet 270 is placed within the magnetic field of the coil 240, the first magnet 270 is positioned under the first magnetic member 242. When the second magnet 272 is placed within the magnetic field of the coil 240, the second magnet 272 is positioned under the second magnetic member 244.

The coil 240 is rested on the frame 210 and a cover plate 290 is fixed in order to prevent the drive plate 260 from escaping. The cover plate 290 is provided with a third opening 292 formed to be aligned with the first opening 222.

An electronic device where a small camera equipped with the shutter apparatus of the fourth embodiment is provided with a controller for supplying electric power to the coil 240. In addition, the electronic device is provided with buttons for operating the controller so as to open and close the shutter apparatus.

An elongated hole 282 is formed in the blade 280 and the drive plate 260 is provided with a protrusion to be engaged with the elongated hole 282.

On the other hand, the drive plate 260 may be escaped from the frame 210. Thus, a separate cap is installed outside of the drive plate 260 to avoid escaping of the drive plate 260. The blade 280 is positioned between the shield plate 220 and the drive plate 260 and thus its escape is avoided.

Hereinafter, the operation of the above-configured shutter apparatus will be explained.

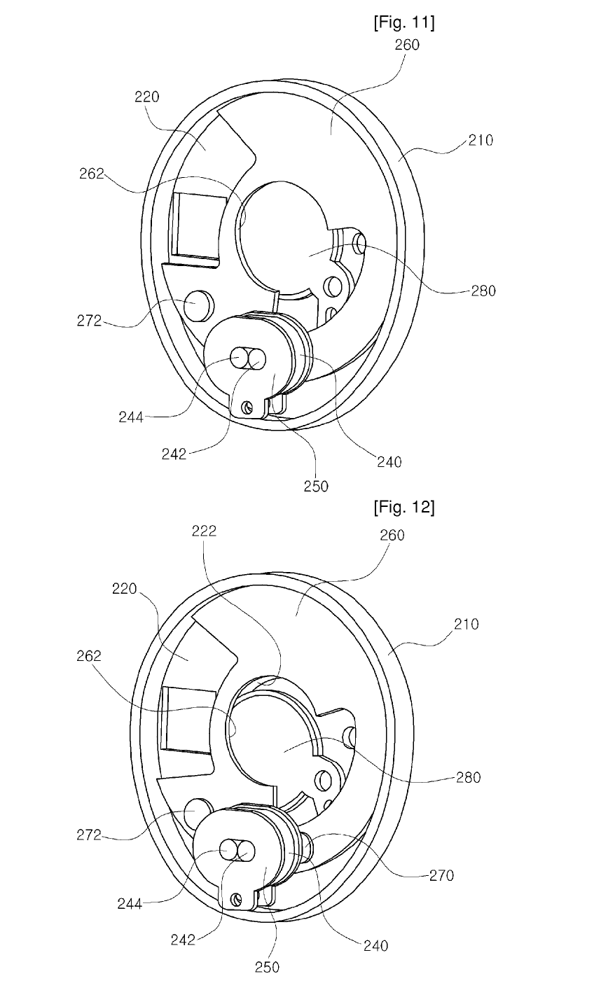

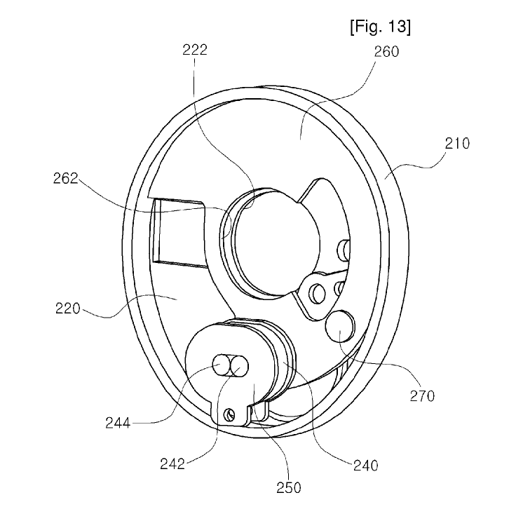

FIG. 11 is a perspective view of the shutter apparatus of FIG. 8 where the cover plate thereof is excluded. FIGS. 12 and 13 show the shutter apparatus of FIG. 11 when in use.

The first magnet 270 attracts the first magnetic member 242 such that the blade 280 closes the first opening 222 of the shield plate 220 and the second opening of the drive plate 260. Thus, as shown in FIG. 11, the blade 280 closes the opening of the small camera, so that foreign matters can be prevented from in-flowing into the camera.

In order to use the small camera, when a user presses an open button of the device, the controller supplies a forward electric power to the coil 240.

Therefore, a magnetic field occurs in the coil 240, the first magnetic member 242 and the second magnetic member 244. The polarity of this magnetic filed is identical to the first magnet 270. Thus, due to repulsion force, the first magnet 270 moves away from the first magnetic member 242. The second magnet 272 having an opposite polarity to the magnetic field is attracted to the second magnetic member 244.

During this course of actions, the drive plate 260 to which the first magnet 270 and the second magnet 272 are fixed rotates. The protrusion 264 formed in the drive plate 160 is engaged into the elongated hole 282 of the blade 280 so as to rotate the blade 280, as shown in FIG. 12.

The protrusion 264 is cooperated with the elongated hole 280 to transfer a driving force such that the drive plate 260 rotates the blade 280 without resistance during the rotation.

Due to the rotation of the blade 280, the first opening 222 of the shield plate 220 and the second opening 262 of the drive plate 260 are opened, as shown in FIG. 13.

In this way, if the first opening 222 and the second opening 262 are opened, light can get through the camera opening and thus the camera can be used to take a picture of a subject.

In addition, if the closing button of the electronic device is pressed, a reverse electric power is applied to the coil 240. The first magnet 270 and the second magnet 272 are operates in opposite direction and consequently the drive plate 260 and the blade 280 is driven in opposite direction. Then, the first opening 222 and the second opening 262 are closed, as shown in FIG. 11.

As above, if the first opening 222 is closed, the camera opening is closed to thereby prevent introduction of foreign matters into the camera.

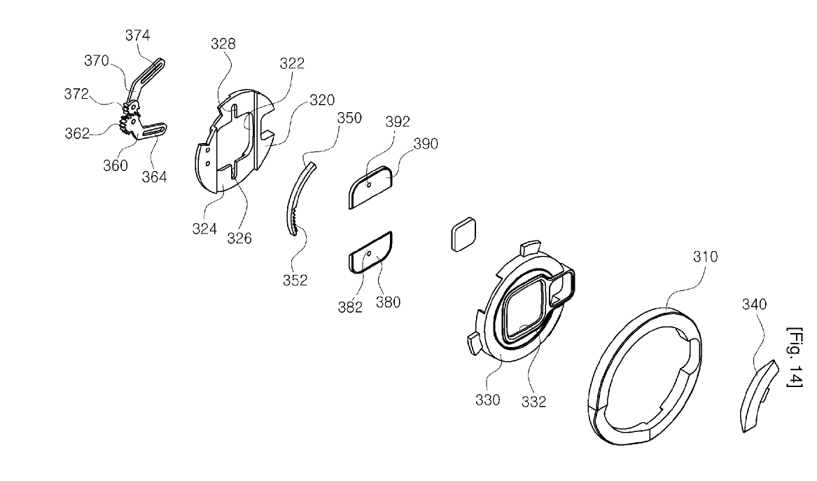

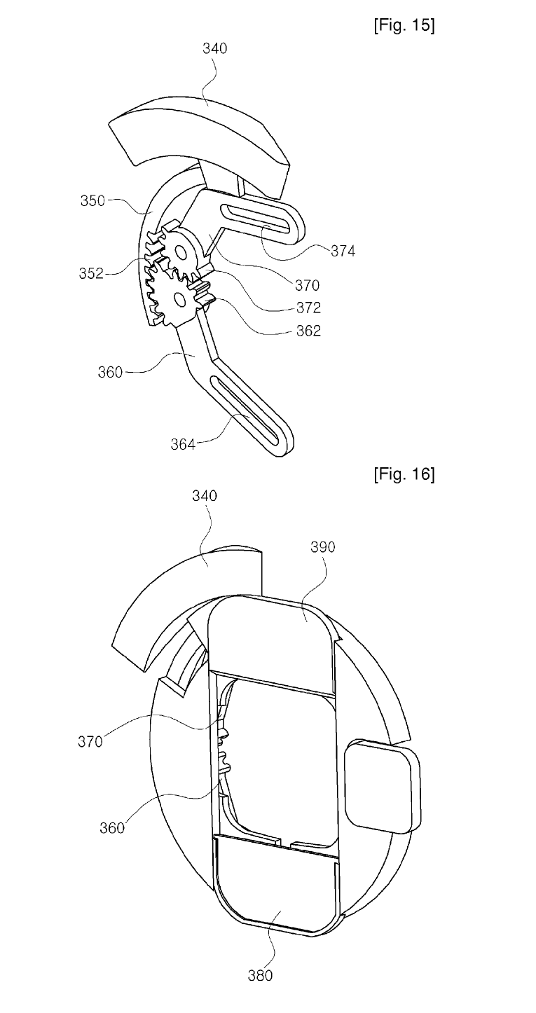

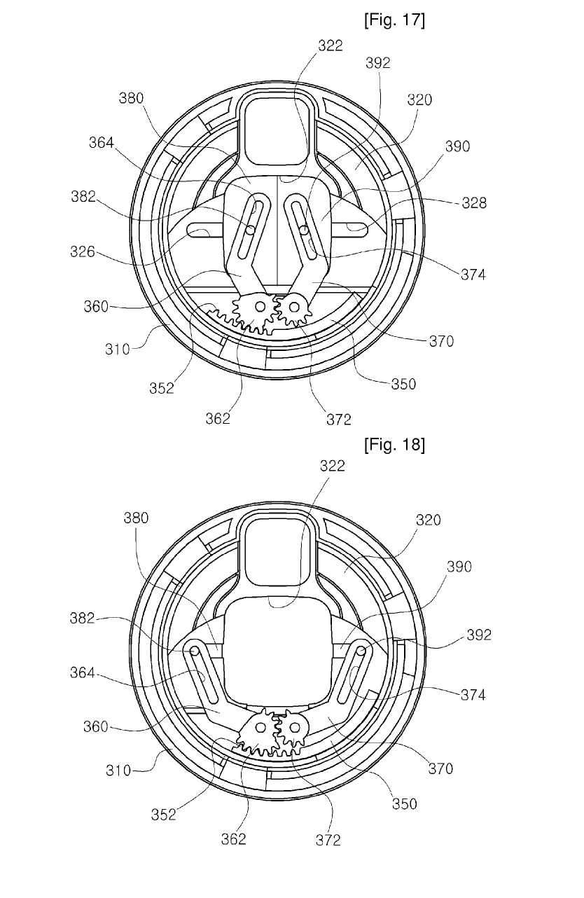

FIG. 14 is an exploded perspective view of a shutter apparatus for small cameras according to a fifth embodiment of the invention. FIGS. 15 and 16 is a perspective view showing major components of the shutter apparatus of FIG. 14. FIGS. 17 and 18 are sectional view showing operation of the shutter apparatus of FIG. 14.

The shutter apparatus for small cameras shown in FIGS. 14 to 18 includes a ring-shaped frame 310 fixed to the edge of the opening of a small camera. A shield plate 320 is installed in the central region of the frame 310 and has a first opening 322 formed so as to open the opening. A handle 340 is slidably installed on the frame 310. A rack gear 350 is fixed to the handle so as to enable to slide and has a first gear tooth 352 formed therein. A first link 360 is shaft-supported on the shield plate 320. The first link 360 has a second gear tooth 362 engaged with the first gear tooth and formed on a circumference having a desired radius from the shaft-supported rotation center. A first blade 380 is slidably installed in the shield plate 320 so as to receive the rotation of the first link 360 in the form of a linear motion to open and close the first opening 322.

The frame 310 is installed on the edge of the opening of a small camera, which is to be opened to transmit light into the lens of the camera. The small camera is completely closed from the outside except for the camera opening.

The frame 310 has a ring shape, and the handle 340 is installed to rotate along the frame 310 by a certain length.

A first elongated slot 364 is formed in the first link 360. The first blade 380 is provided with a first protrusion 382 formed so as to be coupled with the first elongated slot 364.

A cover plate 330 is coupled to the frame to prevent escape of the handle 340 and the first blade 380.

In addition, a second link 370 is shaft-supported on the shield plate 320. The second link 372 includes a third gear tooth 372 to be tooth-engaged to the second gear tooth 362 and formed on a circumference having a desired radius from the shaft-supported rotation center. Thus, the first link 360 and the second link 370 are engaged with each other so as to rotate in opposite direction to each other.

In addition, a second blade 390 is provided so as to receive the rotation of the second link 370 in the form of a linear motion and slide on the shield plate 320, thereby enabling to open and close the first opening 322. The first blade 380 and the second blade 390 approach to each other at the same time from both sides to close the first opening 322 or move away from each other at the same time to open the first opening 322.

The shield plate 320 is provided with a sliding plane 324 formed to have a height different from the other portion thereof such that the first blade 380 and the second blade 390 are guided so as to perform a linear motion.

In addition, the shield plate 320 is provided with a first slide groove 326 and a second slide groove 328 formed such that the first protrusion and the second protrusion 392 can be moved therein.

In this way, two blades are used to open and close the first opening 322 twice faster. In addition, since two blades are involved, the size of each blade can be reduced in halves to thereby allow the blades to smoothly move within a limited space.

A second elongated slot 374 is formed in the second link 370 and the second blade 390 is provided with a second protrusion 392 formed to be coupled to the second elongated slot 374.

A second opening 332 is further provided so as to be aligned with the first opening 322. The second opening 332 is coupled to the frame 310 to prevent escaping of the handle 340, the first blade 380 and the second blade 390. Thus, the handle 340, the first blade 380 and the second blade 390 are rested on the shield plate 320 and the cover plate 330.

In addition, a plate may be installed in the frame such that the first link 360 and the second link 370 are prevented from escaping from under the shield plate 320.

Hereinafter, the operation of the above constructed shutter apparatus will be explained in greater detail.

If a user pushes the handle 340 using his or her finger, the rack gear fixed to the handle 340 rotates. Thus, the first link 360 turns since the first gear tooth 352 of the rack gear 350 is engaged with the second gear tooth of the first link 360. The third gear tooth 372 engaged with the second gear tooth 362 turns in the opposite direction to the first link 360.

Then the first link 360 and the second link 370 are departed from each other simultaneously to open the first opening 322.

The first protrusion 382 of the first blade 380 is coupled to the first elongated slot 362 of the first link 360. Thus, the rotation of the first link 360 can be converted into linear motion of the first blade 380 without resistance. In addition, the second protrusion 392 of the second blade 390 is coupled to the elongated slot 374 of the second link 370. Therefore, the rotation of the second link 370 can be converted into linear motion of the second blade 390 without resistance.

In this way, when the first opening is opened, the small camera can receive light through the opening to thereby enable the camera function.

In addition, when the handle is turned in the opposite direction, the above operation is performed in a reverse direction such that the first and second blades 380 and 390 close the first opening 322.

In this way, if the first opening 322 is closed, then the camera opening is closed to prevent instruction of foreign matters into the small camera.

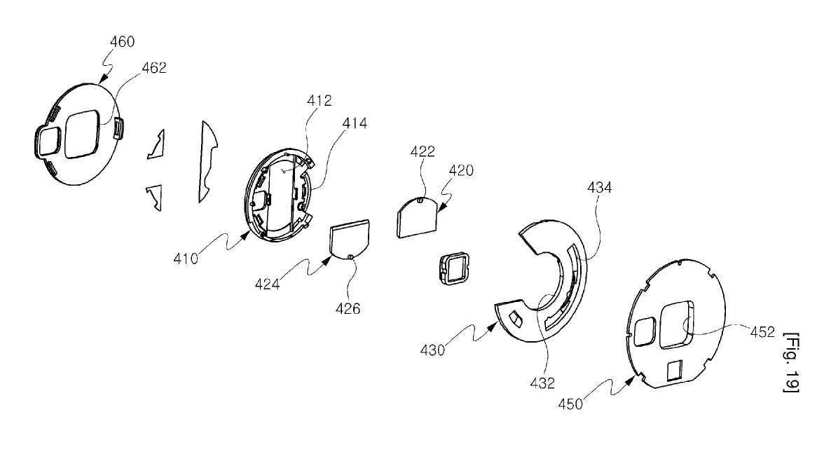

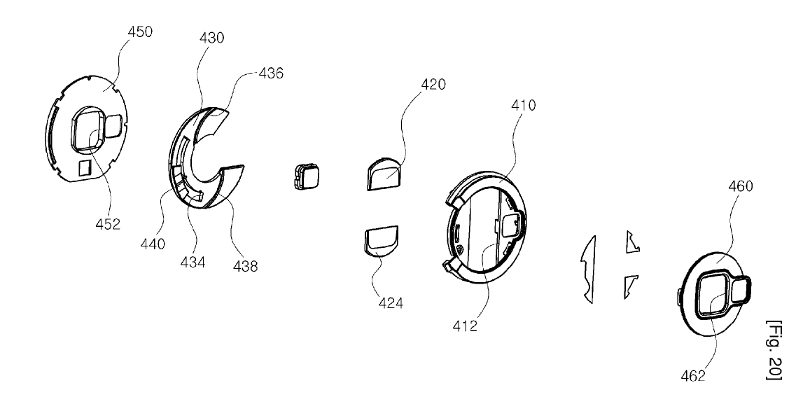

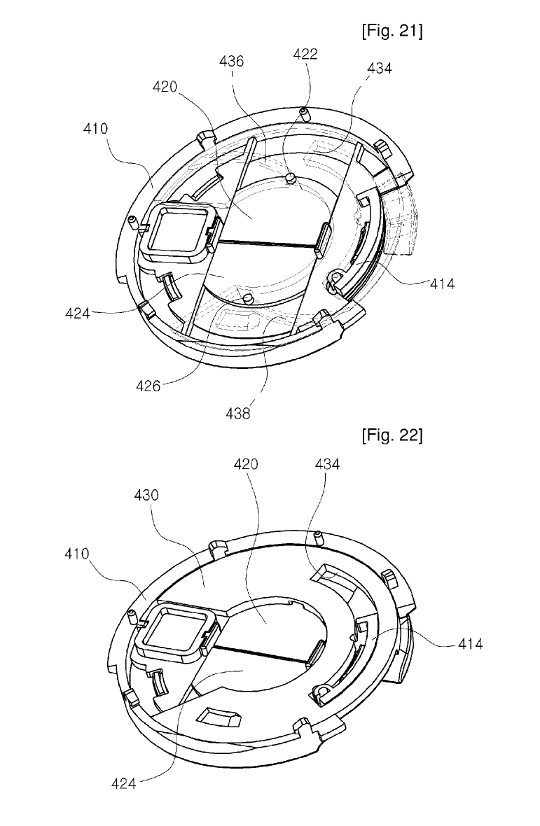

FIG. 19 is an exploded perspective view of a shutter apparatus for small cameras according to a sixth embodiment of the invention. FIG. 20 is an exploded perspective view of the shutter apparatus of FIG. 19 seen from a different angle. FIG. 21 is a perspective view showing the internal structure of the shutter apparatus of FIG. 19.

The shutter apparatus for small camera illustrated in the figures is installed in the front side of a small camera to prevent introduction of foreign matters into the inside of the camera.

The shutter apparatus includes a shield frame 410 to be installed frontward of the lens of a camera and having a sliding space 412 for opening the front side of the lens and a blade having a protrusion. The blade slides in the sliding space 412 to open and close the front side of the lens. A rotation lever 430 is rotatably coupled to the shield frame 410. The rotation lever 430 have a central opening 432 formed in the rotation center thereof to open the front side of the lens. In addition, the rotation lever 430 includes a cam groove coupled to the protrusion such that, when rotated, the protrusion is moved to open and close the blade.

The blade includes a first blade 420 and a second blade 424 which are disposed symmetrically to each other. The protrusion includes a first protrusion 422 formed in the first blade 420 and a second protrusion 426 formed in the second blade 424. In addition, the cam groove includes a first cam groove 426 to be coupled to the first protrusion 422 and a second cam groove 438 to be coupled to the second protrusion 426.

In this way, two blades are used to open and close the lens twice faster. In addition, since two blades are involved, the size of each blade 420, 424 can be reduced in halves to thereby allow the blades to smoothly move within a limited space.

On the other hand, a stopping groove 434 is formed in the rotation lever 430. The rotation lever 430 is provided with a guide rib 414 formed so as to be coupled to the stopping groove 434 to limit rotation angle of the rotation lever 430.

In addition, the rotation lever 430 is provided with a handle protruded so as to be pushed by a user.

The above shutter apparatus is provided with a cover member for prevent escaping of the blade connected to the shield frame 410.

The cover member includes a first cover 450 for preventing escape of the rotation lever 430 from the upper side of the shield frame 410, and a second cover 460 for preventing escape of the first blade 420 and the second blade 424 from the lower side of the shield frame 410. The first cover 450 and the second cover 460 are provided with a first opening and a second opening 462 for opening the front side of the lens.

The above-configured shutter apparatus is installed frontward of a small camera equipped in a cellular phone or the like to prevent introduction of foreign matters into the lens area.

Hereinafter, the operation of the above shutter apparatus will be explained in greater detail.

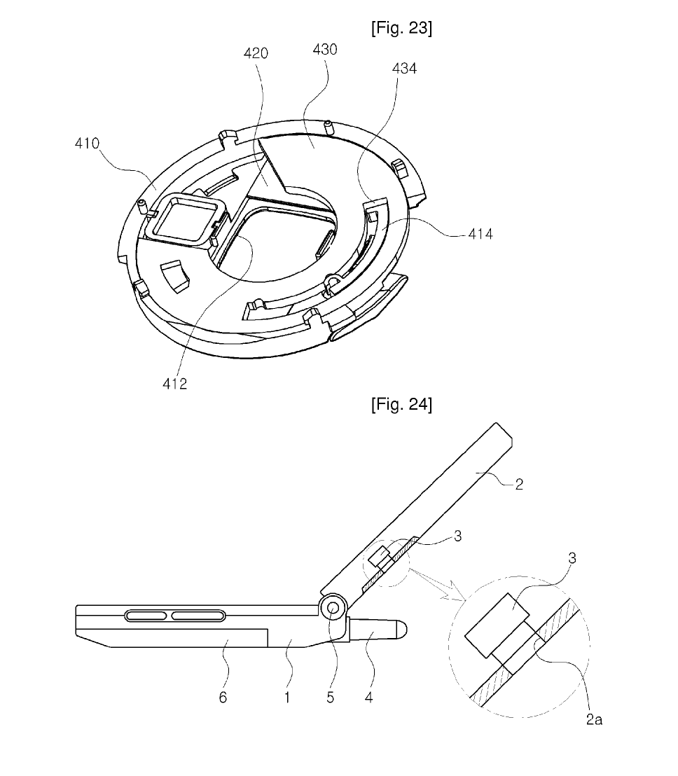

FIG. 22 is a perspective view of the shutter apparatus when closed and FIG. 23 is a perspective view of the shutter apparatus when the blade is opened.

When the camera is not used, the first and second blades 420 and 424 close the front side of the lens so that the camera cannot take a picture.

On the other hand, when the camera is used, the shutter apparatus equipped in the camera is to be opened. To do this, a user pushed the handle 440 of the rotation lever 430 using his or her finger. Then, the rotation lever 430 rotates and thus the first cam groove 436 and the second cam groove 438 moves horizontally the first and second protrusions 422 and 426 such that the first and second blades 420 and 424 are opened. Due to the first and second cam grooves 436 and 438, rotation of the rotation lever 430 is converted into linear motion of the first and second blades 420 and 424.

Therefore, the first and second blades 420 and 424 in the sliding space are departed from each other at the same time to open the lens. Light can enter the camera lens through the opened sliding space 412 to allow the camera to take a picture.

On the other hand, when the camera is not used, the user rotates the handle 440 in reverse direction. Thus, the above operation is carried out in opposite direction such that the first and second blades 420 and 424 close the lens.

In this way, if the sliding space 412 is closed, the inside of the small camera is closed to prevent introduction of foreign matters into the small camera.

Although the present invention has been described with reference to several exemplary embodiments, the description is illustrative of the invention and is not to be construed as limiting the invention. Various modifications and variations may occur to those skilled in the art, without departing from the spirit and scope of the invention, as defined by the appended claims.

1. A shutter apparatus for small cameras, comprising:
a shutter housing to be mounted in an exposure aperture formed in a main body and having a through-hole communicated with the exposure aperture;
a shutter panel pivotably mounted inside the shutter housing so as to open and close the through-hole; and
a pivot lever rotatably installed inside the shutter housing and engaged with the shutter panel such that the shutter panel is pivoted to open and close the throughhole.

2. The apparatus as claimed in claim 1, wherein the shutter panel includes:
a cover portion having a semi-circular shape;
a pivot portion having an expanded region, the pivot portion having at one end portion thereof a pivot hole forming a pivot center; and
a guide portion extended from the pivot portion in opposite direction to the cover portion and having a guide hole in the form of an elongated slot.

3. The apparatus as claimed in claim 2, wherein the pivot lever has an annular disk shape having an inner diameter corresponding to the through-hole, a guide pin formed at 180 degrees intervals so as to be inserted into the guide hole, and a handle formed in the periphery thereof so as to be protruded outside of the shutter housing.

4. The apparatus as claimed in claim 3, further comprising a tension spring, in which one end of the tension spring is fixed to the pivot lever and the other end thereof is fixed to the shutter housing such that a force is exerted in the direction of closing the shutter panel, thereby the shutter panel remaining at closed state.

5. The apparatus as claimed in claim 2, wherein the shutter housing has a pivot protrusion formed at 180 degree intervals so as to be inserted into the pivot hole.

6. The apparatus as claimed in claim 1, wherein the pivot lever is provided with at least one resilient stopper and the shutter housing is provided with a stopper retainer hole for temporarily holding the stopper such that the shutter panel and the pivot lever are temporarily held in place at open and closed state of the through-hole.

7. The apparatus as claimed in claim 1, further comprising an adhesive sheet for attaching the shutter housing to the main body.

8. The apparatus as claimed in claim 1, further comprising a cover mounted on an outer side face of the main body and for wrapping around and fixing the shutter housing.

9. A shutter apparatus for small cameras, the apparatus comprising:
a hollow frame fixed at the edge of an opening of a main body;
a shield plate installed in a central area of the frame, the shield plate having a first opening for opening the opening of the main body;
a wound coil fixed on the frame, the wound coil establishing an electromagnetic field by a power supply;
a controller for selectively supplying a forward and reverse current;
a drive plate rotatably installed in the frame so as to be parallel to the shield plate, the drive plate having a second opening formed so as to be aligned with the first opening;
a first magnet and second magnet fixed on the drive plate with a certain distance in-between so as to be alternatively placed within the electromagnetic field, the polarities of the magnets towards the wound coil being in opposite to each other;
a blade shaft-supported on the shield plate so as to be contacted with the drive plate such that the blade is pivoted by rotation of the drive plate to thereby open and close the first opening.

10. The apparatus as claimed in claim 9, wherein a magnetic member is fixed to a center of the coil, the magnetic member concentrating magnetic field to one of the first magnet and the second magnet.

11. The apparatus as claimed in claim 9, wherein the blade is provided with an elongated hole, and the drive plate is provided with a protrusion so as to be engaged with the elongated hole.

12. The apparatus as claimed in claim 9, further comprising a cover plate combined to the frame for the coil to be rested thereon and for preventing the drive plate from being escaped, the cover plate having a third opening formed to be aligned with the first opening.

13. A shutter apparatus for small cameras, the shutter apparatus comprising:
a ring-shaped frame fixed to the edge of an opening of a main body;
a shield plate installed in the central region of the frame and having a first opening formed so as to open the opening of the main body;
a handle slidably installed on the frame;
a rack gear fixed to the handle so as to enable the handle to slide and having a first gear tooth formed therein;
a first link shaft-supported on the shield plate, the first link having a second gear tooth engaged with the first gear tooth and formed on a circumference having a desired radius from the shaft-supported rotation center; and
a first blade slidably installed in the shield plate so as to receive the rotation of the first link in the form of a linear motion to open and close the first opening.

14. The apparatus as claimed in claim 13, wherein a first elongated slot is formed in the first link and the first blade is provided with a first protrusion formed so as to be coupled to the first elongated slot.

15. The apparatus as claimed in claim 13, further comprising a cover plate coupled to the frame such that the handle and the first blade are prevented from escaping.

16. The apparatus as claimed in claim 13, further comprising:
a second link shaft-supported on the shield plate, the second link including a third gear tooth to be engaged with the second gear tooth and formed on a circumference having a desired radius from the shaft-supported rotation center; and
a second blade slidably installed in the shield plate so as to receive the rotation of the second link in the form of a linear motion to open and close the first opening.

17. The apparatus as claimed in claim 15, wherein a second elongated slot is formed in the second link and the second blade is provided with a second protrusion formed so as to be coupled to the second elongated slot.

18. The apparatus as claimed in claim 16, further comprising a cover plate coupled to the frame such that the handle and the first and second blades are prevented from escaping, the cover plate being provided with a second opening formed so as to be aligned with the first opening.

19. A shutter apparatus for small cameras, the apparatus comprising:
a shield frame being installed frontward of the lens of a camera and having a sliding space for opening the front side of the lens;
a blade sliding in the sliding space to open and close the front side of the lens, the blade having a protrusion; and
a rotation lever rotatably coupled to the shield frame, the rotation lever including a central opening formed in a rotation center thereof to open the front side of the lens and a cam groove coupled to the protrusion such that the protrusion moves to open and close the blade, when the rotation lever rotates.

20. The apparatus as claimed in claim 19, wherein the blade includes a pair of blades symmetrically disposed, and the protrusion and the cam groove includes a pair of protrusions and a pair of cam grooves, respectively.

21. The apparatus as claimed in claim 19, wherein a stopping groove is formed in one of the shield frame and the rotation lever, and the other one thereof is provided with a guide rib formed to be coupled to the stopping groove to limit rotation angle of the rotation lever.

22. The apparatus as claimed in claim 19, wherein the rotation lever is provided with a handle protruded so as to be pushed by a user.

23. The apparatus as claimed in claim 19, further comprising a cover member to be coupled to the shield frame to thereby prevent escape of the blade.
